(19) United States
(12) Patent Application Publication
(10) Pub. No.: US 2016/0344838 A1
(43) Pub. Date: Nov. 24, 2016

(54) CACHING OF TRACKING ELEMENTS IN NETWORK CONTENT

(71) Applicant: Fastly, Inc., San Francisco, CA (US)

(72) Inventors: Simon Wistow, Oakland, CA (US); Rogier Mulhuijzen, Den Haag (NL)

(21) Appl. No.: 14/718,388

(22) Filed: May 21, 2015

(51) Int. Cl. H04L 29/08

(52) U.S. Cl. CPC H04L 67/2852; H04L 67/02

(57) ABSTRACT

Systems, methods, apparatuses, and software for caching tracking elements of network content are provided herein. In one example, a method of operating a cache node that caches content for delivery to end user devices is provided. The method includes caching web page content and a tracking element, the web page content comprising a portion corresponding to the tracking element. The method also includes receiving a content request from an end user device for the portion of the web page content corresponding to the tracking element and responsively providing the tracking element to the end user device. The method also includes identifying properties of the end user device based at least on the content request, and transferring the properties of the end user device for delivery to a tracking system.

### TECHNICAL FIELD

Aspects of the disclosure are related to the field of packet communication networks and delivery of content from content servers to end user devices.

### TECHNICAL BACKGROUND

Network-provided content, such as Internet web pages or media content such as video, pictures, music, and the like, are typically served to end users via networked computer systems. End user requests for the network content are processed and the content is responsively provided over various network links. These networked computer systems can include origin or hosting servers which originally host network content, such as web servers for hosting a news website. However, these computer systems of individual content origins or hosts can become overloaded and slow due to frequent requests of content by end users.

Content delivery networks have been developed which add a layer of caching between original servers of the content providers and the end users. The content delivery networks typically have one or more content nodes distributed across a large geographic region to provide faster and lower latency access to the content for the end users. When end users request content, such as a web page, which is handled through a content node, the content node is configured to respond to the end user requests instead of the origin servers. In this manner, a content node can act as a proxy or cache for the origin servers. Content of the origin servers can be cached into the content nodes, and can be requested via the content nodes from origin servers when the content has not yet been cached.

Additionally, network content, such as web pages, can include tracking elements, such web bugs, beacons, or tracking pixels which are used to determine when users have viewed various network content, such as in a web browser application. Various statistical data for the content browsing activities of the end users can be monitored for web analytics, page tagging, advertisement selection, among other activities. Certain types of content, such as application programming interface (API) results or dynamically generated HTML, can be difficult to cache. Additionally, user tracking elements, such as cookies, are also difficult to manage because they are typically personal and user specific.

### Overview

Systems, methods, apparatuses, and software for caching tracking elements of network content are provided herein. In one example, a method of operating a cache node that caches content for delivery to end user devices is provided. The method includes caching web page content and a tracking element, the web page content comprising a portion corresponding to the tracking element. The method also includes receiving a content request from an end user device for the portion of the web page content corresponding to the tracking element and responsively providing the tracking element to the end user device. The method also includes identifying properties of the end user device based at least on the content request, and transferring the properties of the end user device for delivery to a tracking system.

In another example, a computer apparatus to operate a cache node that caches content for delivery to end user devices is provided. The computer apparatus includes processing instructions that direct the cache node, when executed by the cache node, to cache web page content comprising a portion corresponding to a tracking element, receive a content request from an end user device for the portion of the web page content corresponding to the tracking element, identify properties of the end user device based at least on the content request, and transfer the properties of the end user device for delivery to a tracking system. The computer apparatus also includes one or more non-transitory computer readable media that store the processing instructions.

In another example, a cache node that caches content for delivery to end user devices is provided. The cache node includes a storage system configured to cache web page content comprising a portion corresponding to a tracking element. Responsive to a content request from an end user device for the portion of the web page content corresponding to the tracking element, the cache node includes processing circuitry configured to identify properties of the end user device based at least on the content request. The cache node includes a network interface configured to transfer the properties of the end user device for delivery to a tracking system.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the views. While multiple embodiments are described in connection with these drawings, the disclosure is not limited to the embodiments disclosed herein. On the contrary, the intent is to cover all alternatives, modifications, and equivalents.

FIG. 1 illustrates a communication system.

FIG. 2 illustrates a method of operation of a content node.

FIG. 3 illustrates a communication system.

FIG. 4 illustrates method of operation of a content delivery network.

FIG. 5 illustrates method of operation of a content delivery network.

FIG. 6 illustrates a content node.

### DETAILED DESCRIPTION

Network content, such as web content, typically comprises text, hypertext markup language (HTML) pages, pictures, digital media content, video, audio, code, scripts, or other content viewable and rendered by an end user device in a browser or other specialized application. This network content can also include tracking elements, such as web bugs, web beacons, tracking pixels, Javascript tag, page tags, clear GIF images, 1×1 pixel GIFs, or cookies, among other tracking elements. These tracking elements can be used to determine information about network content browsing activities, for web analytics, hit rate calculations, among others.

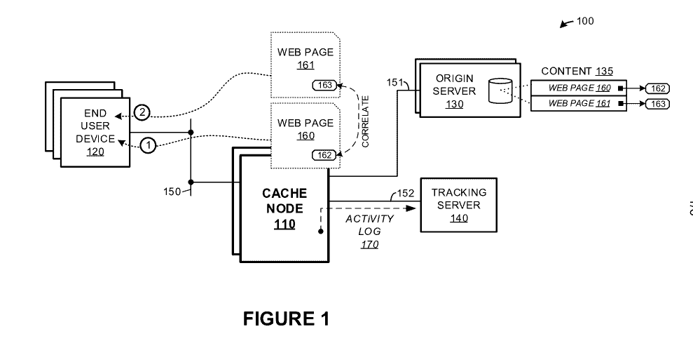

In some examples, the network content can be stored and served by origin servers that are owned or operated by content originators. Tracking elements can be stored and served by different content providers than the content originators associated with the origin servers. However, when cache nodes or content delivery network are employed, such as in FIG. 1, the cache nodes can act as proxies that cache network content and tracking elements for delivery to end user devices. The cache nodes can maintain recently accessed and popular content as cached from the content sources or origin servers. Thus, cache nodes exchange data with the content sources when new or un-cached information is requested by the end users or if data has changed in the content source data.

Content delivery networks can add a layer of caching between origin servers of the content providers and the end users. The content delivery networks typically have one or more cache nodes distributed across a large geographic region to provide faster and lower latency local access to the content for the end users. When end users request content, such as a web page, a selected cache node will respond to the content request instead of the associated origin server. Various techniques can be employed to ensure the cache node responds to content requests instead of the origin servers, such as associating web content of the origin servers with network addresses of the cache nodes instead of network addresses of the origin servers using domain name system (DNS) registration and lookup procedures. Although cache nodes and origin servers are shown as different nodes in the examples herein, it should be understood that the origin servers and cache nodes can be included in one or more of the same nodes.

As a first example employing a content delivery network, FIG. 1 is a system diagram illustrating communication system 100. Communication system 100 includes cache node 110, end user device 120, origin server 130, and tracking server 140. Cache node 110 and end user device 120 communicate over packet network 150. Cache node 110 and origin server 130 communicate over network link 151. Cache node 110 and tracking server 140 communicate over network link 152.

In operation, cache node 110 caches content of at least origin server 130. This content can include web pages, media content, data, executable code, scripting content, among other types of content deliverable over packet network 150. Cache node 110 delivers content upon request to end user device 120 over packet network 150. By caching the content of origin server 130 or other origin servers, cache node 110 can provide faster access to this content to end user devices, such as end user device 110. In many examples, a plurality of cache nodes are included in a content delivery network (CDN) which provides cache nodes distributed over a large geographic area for lower latency access to content normally provided by one or more origin servers. Cache node 110 can also cache dynamic content, such as content generated responsive to activities of end user device 120.

To provide various supplemental services to end user device 110, such as custom-tailored content, specific advertisement content, or other supplemental content for end user devices, the content request activities of the end user devices can be tracked. Furthermore, the content request activities of end user devices can be tracked in an anonymous or semi-anonymous manner to provide various statistical information to allow origin servers or other content providers to determine usage information, traffic patterns, hit rates, advertisement conversion rates, among other statistical and analytics information associated with content requests of end user devices.

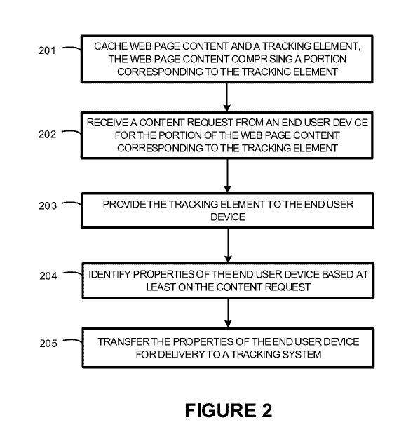

To further illustrate example operations of system 100, FIG. 2 is provided. FIG. 2 is a flow diagram illustrating a method of operating cache node 110. The operations of FIG. 2 are referenced below parenthetically. In FIG. 2, cache node 110 caches (201) web page content and a tracking element, the web page content comprising a portion corresponding to the tracking element. The portions of the web page content corresponding to the tracking elements can include links, pointers, hyperlinks, Javascript references, or other correspondences.

In FIG. 1, two example web pages are cached by cache node 110, namely web pages 160-161. These web pages can be originally hosted by origin server 130, such as shown in FIG. 1, although separate origin servers can be used. Cache node 110 can cache any of web pages 160-161 in one or more storage media of cache node 110. The caching can be responsive to end user requests for the associated web page content or preemptive before end user requests. Cache node 110 can cache the web pages themselves, along with any content linked to or referenced by the web pages.

Web pages 160-161 can include any web content accessible through a browser application or specialized application executed by end user device 120. For example, web pages 160-161 can include various code and scripts which link to media content, pictures, audio, text, objects, forms, data, or other network content. Web pages 160-161 can include hypertext markup language (HTML), Javascript, executable code, scripts, cascading style sheets (CSS), links, or extensible markup language (XML), among other elements and content types.

Web pages 160-161 can also include portions corresponding to one or more tracking elements, as noted by associated tracking elements 162-163. These tracking elements can comprise web bugs, web beacons, tracking pixels, Javascript tag, page tag, clear GIF image, 1×1 GIF, or other tracking elements, including combinations thereof. Initially, origin server 130 includes web pages 160-161 which each point to associated tracking elements 162-163. In examples that do not employ cache node 110, tracking elements 162-163 can each be stored on servers or systems separate from origin server 130, and when a user requests any of tracking elements 162-163 then those servers or systems separate from origin server 130 can optionally deliver content related to tracking elements 162-163. However, in the examples discussed herein, a different operation is followed by cache node 110.

Specifically, in this example, cache node 110 receives (202) a content request from end user device 120 for the portion of the web page content corresponding to the tracking element. In a first web page example (as noted in FIG. 1 by indicator ‘1’), end user device 120 requests web page 160 along with any associated network content pointed to by web page 160, such as images, code, text, and the like. Web page 160 is cached by cache node 160 and links to tracking element 162, namely a URL which points to tracking elements 162. To complete the retrieval of web page 160, end user device 120 issues a content request for tracking element 162, such as by using an HTTP GET request to a URL associated with tracking element 162 as linked in web page 160. Other forms of content request are possible, such as HTTP POST request methods. The content request accompanied by one or more parameters, which can comprise query parameters for a URL requested.

Responsive to the content request, cache node 110 provides (203) tracking element 162 for delivery to end user device 120. In this example, cache node 110 has already cached tracking element 162, and can deliver tracking element 162 to end user device 120 accordingly. However, in other examples, cache node 110 might instead generate tracking element 162 responsive to a content request for tracking element 162, such as when tracking element 162 comprises a transparent image file. In further examples, cache node 110 might not provide tracking element 162, and instead transfer a response which indicates to end user device 120 that no content will be delivered responsive to the content request for tracking element 162.

Cache node 110 identifies (204) properties of end user device 120 based at least on the content request for tracking element 162. The properties can be identified based on the parameters which accompany the content request. In one example, the properties are identified based at least on the query parameters which accompany a URL associated with tracking elements 162. The properties can include various information about the content request, such as a network address originating the content request, an identity or address of the web page associated with the content request, a time of the content request, or other properties. Additionally, the properties can include various information about the software environment of end user device 120, such as browser type, application type, or operating system, among other information.

In some examples, cache node 110 can associate a tracking identifier with the content request, which can be correlated to end user device 120. This tracking identifier can be used to correlate further content requests for web pages or tracking elements to the same end user device 120. Furthermore, cache node 110 can store the various properties or parameters associated with the content request or end user device. Cache node 110 can store the various properties or parameters for use in correlation to the same tracking identifier across multiple content requests, even for different web pages associated with different domain names, network addresses, or origin servers. For example, end user device 120 might access web page 161 and subsequently request tracking element 163. Cache node 110 can correlate properties identified with a content request for tracking element 162 and tracking elements 163 to determine that end user device 120 made both content requests. Other information can be obtained, such as discussed in the examples below.

Cache node 110 transfers (205) the properties of end user device 120 for delivery to a tracking system. In this example, tracking server 140 is employed, and activity log 170 is transferred by cache node 110 for delivery to tracking server 140. Activity log 170 can be transferred after a predetermined number of content requests, end users, or time thresholds are reached, among other considerations. Activity log 170 can include the properties identified for more than one end user device, more than one web page, and over a period of time. Also, various correlations between the information or properties as determined by cache node 110 can be transferred to tracking server 140.

In some examples, tracking server 140 is a web analytics engine or advertisement server. Tracking elements 162-163 can be hosted by tracking server 140 and subsequently cached by cache node 110 once associated web page content is cached by cache node 110, such as web pages 160-161. In examples without a cache node employed, an end user device might have to retrieve web page content from origin server 130 and then retrieve tracking element content from tracking server 140, which is a slow and cumbersome process. Advantageously, cache node 110 can cache both the web page content and tracking elements. Furthermore, cache node 110 can store properties related to the content requests for the tracking elements before delivery to further systems, such as tracking server 140. Cache node 110 can perform analysis on the properties to correlate content requests among end user devices, along with other operations as discussed herein.

In a specific example, cache node 110 can cache second web page content, such as web page 161 noted above, and a second tracking element 163. The second web page content comprises a portion corresponding to second tracking element 163, such as a hyperlink, pointer, Javascript reference, or other correspondence. Cache node 110 receives a second content request from end user device 120 for tracking element 163 and responsively provides tracking element 163 to end user device 120 from the cache or storage portions of cache node 110. Cache node 110 identifies second properties of the end user device based at least on the second content request for tracking element 163. Cache node 110 correlates the properties identified from the content request for tracking element 162 to the second properties identified from the second content request for tracking element 163 to determine that both content requests are correlated with the same end user device, namely end user device 120. Cache node 110 can then transfer for delivery to tracking system 140 the second properties of the end user device and an indication that the second properties are associated with the first properties.

The examples above discuss tracking elements embedded in web-based network content, such as web bugs, web beacons, tracking pixels, Javascript tag, page tags, clear GIF images, 1×1 pixel GIFs. However, the above examples (as well as the other examples herein) can also apply to tracking cookies used with web content. Tracking cookies are used in network content, such as websites, e-commerce systems, and advertising websites, to follow users during a first associated session on the site and again on any subsequent site visits. User behavior (such as which pages the users hit or request, how long the users stay on a web page, and the like) provides valuable long-term and aggregate information about site flow and usability. When a user visits a web site for the first time, the user is transferred a cookie which uniquely identifies the user or user device. In FIG. 1, tracking elements 162 or 163 can comprise tracking cookies. Then, whenever that same user or user device returns to the site, the identifier can be analyzed and aggregated to help measure behavior and patterns.

When a user makes a request to for a web site or associated content without a cookie initially located on the user device, a cache node can responsively request a cookie for that user from the associated origin server. Additionally, the content associated with the web site can be requested from the origin server by the cache node along with the cookie request. The origin server can respond with any requested content along with any requested cookie. Once received, the cache node can cache the content in the cache node but remove the cookie from any associated content that is delivered by the origin server. The cookie can be transferred along with the content for delivery to the user device by the cache node. The user device, such as a browser application, displays the content and stores the cookie in a local storage system of the user device.

When that same user or user device revisits the web site originally requested, the cache node can receive the cookie from the user device which was stored previously by the user device. This cookie can be processed to identify user information or user device information, such as a unique identifier associated with a user device, generated earlier during the first visit or request above and stored using the cookie in the user device. The cache node then transfers the user device information, such as the unique identifier, to an origin server or tracking system. The tracking system or origin server can use this unique identifier to provide insight into web site browsing behavior or end user behavior. In a further example, a cache node can generate any necessary cookies in the cache node instead of requesting cookies from an origin server. Thus, in the further example, only website content is requested and cached in the cache node, and any user requests for that content can responsively have the cache node generate cookies for the content without involvement of the origin server.

Returning to the elements of FIG. 1, cache node 110 can include communication interfaces, network interfaces, processing systems, computer systems, microprocessors, storage systems, storage media, or some other processing devices or software systems, and can be distributed among multiple devices. Examples of cache node 110 can include software such as an operating system, logs, databases, utilities, drivers, networking software, and other software stored on a computer-readable medium.

End user device 120 can be a user device, subscriber equipment, customer equipment, access terminal, smartphone, personal digital assistant (PDA), computer, tablet computing device, e-book, Internet appliance, media player, game console, smartwatch, or some other user communication apparatus, including combinations thereof.

Origin server 130 can include communication interfaces, network interfaces, processing systems, computer systems, microprocessors, storage systems, storage media, or some other processing devices or software systems, and can be distributed among multiple devices. Examples of origin server 130 can include software such as an operating system, logs, databases, utilities, drivers, networking software, and other software stored on a computer-readable medium.

Tracking server 140 can include communication interfaces, network interfaces, processing systems, computer systems, microprocessors, storage systems, storage media, or some other processing devices or software systems, and can be distributed among multiple devices. Examples of tracking server 140 can include software such as an operating system, logs, databases, utilities, drivers, networking software, and other software stored on a computer-readable medium.

Communication links 150-152 each use metal, glass, optical, air, space, or some other material as the transport media. Communication links 150-152 can each use various communication protocols, such as wireless communications, cellular communications, Long Term Evolution (LTE), IEEE 802.11 (WiFi), Internet Protocol (IP), Ethernet, synchronous optical networking (SONET), hybrid fiber-coax (HFC), circuit-switched, communication signaling, or some other communication format, including combinations, improvements, or variations thereof. Communication links 150-152 can each be a direct link or can include intermediate networks, systems, or devices, and can include a logical network link transported over multiple physical links. Although one main link for each of links 150-152 is shown in FIG. 1, it should be understood that links 150-152 are merely illustrative to show communication modes or access pathways. In other examples, further links can be shown, with portions of the further links shared and used for different communication sessions or different content types, among other configurations. Communication links 150-152 can each include many different signals sharing the same associated link, as represented by the associated lines in FIG. 1, comprising resource blocks, access channels, paging channels, notification channels, forward links, reverse links, user communications, communication sessions, overhead communications, carrier frequencies, other channels, timeslots, spreading codes, transportation ports, logical transportation links, network sockets, packets, or communication directions.

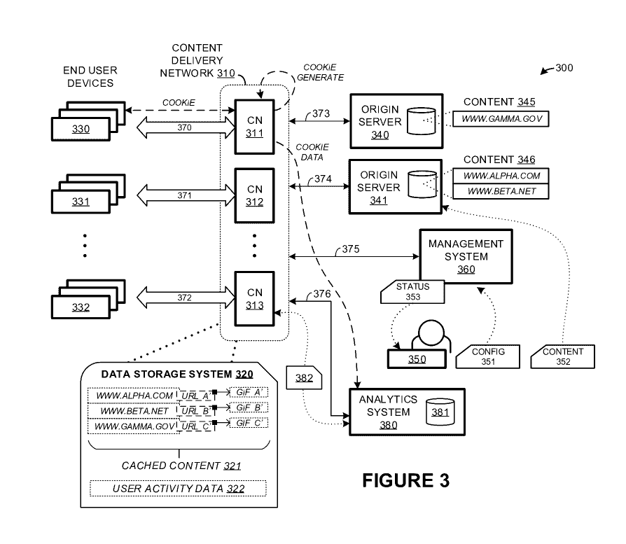

To further illustrate the operation of a content delivery network employing one or more cache nodes, FIG. 3 is presented. FIG. 3 is a system diagram illustrating communication system 300. Communication system 300 includes content delivery network 310, end user devices 330-332, origin servers 340-341, management system 360, and analytics system 380. Content delivery network 310 includes one or more cache nodes (CN) 311-313. Each of CN 311-313 can include one or more data storage systems, such as data storage system 320 of CN 313. End user devices 330-332 are representative of a plurality of end user devices which can request and receive network content, and any number of end user devices 330-332 can be associated with each of content nodes 311-313. CN 311-313 and ones of end users 330-332 communicate over associated network links 370-372. Content delivery network 310 and origin servers 340-341 communicate over associated network links 373-374. Content delivery network 310 and management system 360 communicate over link 375. Content delivery network 310 and analytics system 380 communicate over link 376. Although not shown in FIG. 3 for clarity, each of CN 311-313 can also communicate with each other over one or more network links.

To further illustrate FIG. 3, a brief description of the operation of communication system 300 is included. In operation, end user devices 330-332 request network content, such as content 345-346 associated with origin servers 340-341. Instead of these requests being handled by the individual origin servers 340-341, individual cache nodes 311-313 of content delivery network 310 receive the content requests over ones of links 370-372 and processes the content requests for delivery of the content to the associated end user devices 330-332. Requested network content that is already stored in ones of CN 311-313 can be provided quickly to the end user devices, while network content that is not already stored in ones of CN 311-313 can be responsively requested by an associated one of CN 311-313 from an appropriate origin server 340-341 for delivery by the CN and possible caching by the CN. In this manner, each of CN 311-313 can act as intermediary proxy nodes to provide local and fast access for end user devices 330-332 to network content of origin servers 340-341 without burdening origin servers 340-341. For example, CN 313 includes cached content 321, which can include portions of any of the content originated at origin servers 340-341.

Data storage system 320 shows exemplary cached content for cache node 313, although any of the cache nodes of FIG. 3 can include similar content. Each web page is indicated by a domain name or web address, namely www.alpha.com, www.beta.net, and www.gamma.gov. Also, each web page has an associated URL which points to a tracking element, namely URL ‘A’ linking to GIF image ‘A,’ URL ‘B’ linking to GIF image ‘B,’ and URL ‘C’ linking to GIF image ‘C.’ These linked tracking elements (GIFs in this example) can be cached be content node 313 along with any content associated with the web sites, even if the tracking elements are located on different web servers or origin servers than the other content of the web pages. Furthermore, user activity data 322 can be included in data storage system 320 which comprises the various properties determined for end user devices.

Management system 360 handles configuration changes and status information collection and delivery for system operators and for the origin server operators or managers. For example, operator device 350 can transfer configuration 351 for delivery to management system 360, where configuration 351 can alter the handling of network content requests by CN 311-313, among other operations. Also, management system 360 can monitor status information for the operation of CN 311-313, such as operational statistics, and provide this status information as 353 to operator device 350. Furthermore, operator device 350 can transfer content 352 for delivery to origin servers 340-341 to include in content 345-346. Although one operator device 350 is shown in FIG. 3, it should be understood that this is merely representative and communication system 300 can include many operator devices for receiving status information, providing configuration information, or transferring content to origin servers.

Analytics system 380 can include communication interfaces, network interfaces, processing systems, computer systems, microprocessors, storage systems, storage media, or some other processing devices or software systems, and can be distributed among multiple devices. Examples of analytics system 380 can include software such as an operating system, logs, databases, utilities, drivers, networking software, and other software stored on a computer-readable medium.

Cache nodes 311-313, origin servers 340-341, management system 360, and analytics system 380 can each include communication interfaces, network interfaces, processing systems, computer systems, microprocessors, storage systems, storage media, or some other processing devices or software systems, and can be distributed among multiple devices. Examples of CN 311-313, origin servers 340-341, management system 360, and analytics system 380 can each include software such as an operating system, logs, databases, utilities, drivers, networking software, and other software stored on a computer-readable medium. Content delivery network 310, in addition to including CN 311-313, can include equipment and links to route communications between CN 311-313 and any of end user devices 330-332, origin servers 340-341, management system 360, and analytics system 380, among other operations.

End user devices 330-332 can each be a user device, subscriber equipment, customer equipment, access terminal, smartphone, personal digital assistant (PDA), computer, tablet computing device, e-book, Internet appliance, media player, game console, smartwatch, or some other user communication apparatus, including combinations thereof.

Communication links 370-376 each use metal, glass, optical, air, space, or some other material as the transport media. Communication links 370-376 can each use various communication protocols, such as wireless communications, cellular communications, IEEE 802.11 (WiFi), Long Term Evolution (LTE), Time Division Multiplex (TDM), asynchronous transfer mode (ATM), Internet Protocol (IP), Ethernet, synchronous optical networking (SONET), hybrid fiber-coax (HFC), circuit-switched, communication signaling, or some other communication format, including combinations, improvements, or variations thereof. Communication links 370-376 can each be a direct link or can include intermediate networks, systems, or devices, and can include a logical network link transported over multiple physical links. Although one main link for each of links 370-376 is shown in FIG. 3, it should be understood that links 370-376 are merely illustrative to show communication modes or access pathways. In other examples, further links can be shown, with portions of the further links shared and used for different communication sessions or different content types, among other configurations. Communication links 370-376 can each include many different signals sharing the same associated link, as represented by the associated lines in FIG. 3, comprising resource blocks, access channels, paging channels, notification channels, forward links, reverse links, user communications, communication sessions, overhead communications, carrier frequencies, other channels, timeslots, spreading codes, transportation ports, logical transportation links, network sockets, packets, or communication directions.

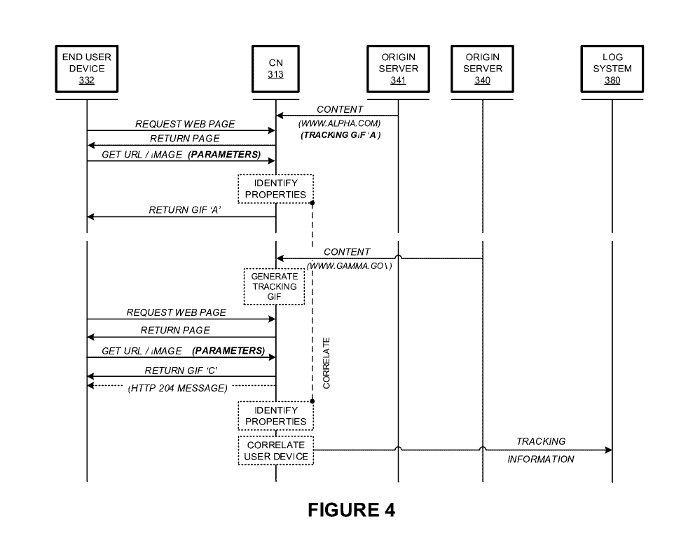

FIG. 4 is a sequence diagram illustrating a method of operating communication system 300. In FIG. 4, end user device 332 requests a web page from cache node 313. The web page can comprise various markup language, text, and scripts which reference other content, such as images, videos, text, and the like. This other content can be referenced in the web page using one or more links or URLs. Among the content associated with the web page, one or more tracking elements can be included. These tracking elements can also be referenced or linked using one or more URLs.

Any end user device in FIG. 3 can request network content from any cache node of content delivery network 310. End user device 332 can follow a domain name lookup process to receive a network address of a particular cache node responsive to a domain name lookup request with a DNS system. This network address can direct content requests for that associated domain name to a selected cache node, specifically cache node 313 in this example. Once the network address is obtained, then end user device 332 issues a content request for a web resource, such as for a web page associated with example domain name www.alpha.com. This content request can comprise one or more HTTP GET or POST request methods which are received by cache node 313.

In this example, cache node 313 has cached network content associated with the requested web page (www.alpha.com) in a data storage system of cache node 313. This caching can occur responsive to the web page request from end user device 332, a previous request from another end user device for network content associated with www.alpha.com, or due to a ‘pre-caching’ process which caches predetermined website content prior to end user requests.

As noted above, among the content associated with www.alpha.com is a tracking element, such as a 1×1 pixel transparent GIF image, noted by tracking GIF ‘A’ in FIGS. 3 and 4. This tracking element can also be cached by cache node 313, and delivered to end user device 332 responsive to a request for the various content associated with www.alpha.com. However, the HTML markup or other associated data for www.alpha.com can include embedded pictures, text, and further URLs that reference other content. The tracking element can be referenced among these further URLs included in www.alpha.com, and thus end user device can request the content for the tracking element referenced by an associated URL. End user device 332 issues a request for the image associated with the tracking element, and the request can include further parameters, such as query string portions, which are included with the request. Cache node 313 then transfers GIF image ‘A’ responsive to the image request by end user device 332.

Cache node 313 can process the parameters or query string portions included with the request for the tracking element to identify various properties of end user device 332. The properties can include various information about the request, such as a network address of end user device 332 originating the request, an identity or address of the web page associated with the content request (such as www.alpha.com), a time of the content request, or other properties. Additionally, the properties can include various information about the software environment of end user device 332, such as browser type, application type, or operating system, among other information. These properties can be included in parameters accompanying the request for the tracking element, the request for the associated web page, or derived from the communications between end user device 332 and cache node 313. The properties associated with end user device 332 and the various content requests for the web page and tracking element can be stored by cache node 313.

In another example content request, end user device 332 requests a web page from cache node 313. As before, the web page can comprise various markup language, text, and scripts which reference other content, such as images, videos, text, and the like. This other content can be referenced in the web page using one or more links or URLs. Among the content associated with the web page, one or more tracking elements can be included. These tracking elements can also be referenced or linked using one or more URLs.

End user device 332 can follow a domain name lookup process to receive a network address of a particular cache node responsive to a domain name lookup request with a DNS system. This network address can direct content requests for that associated domain name to a selected cache node, specifically cache node 313 in this second example. Once the network address is obtained, then end user device 332 issues a content request for a web resource, such as for a web page associated with example domain name www.gamma.gov. This content request can comprise one or more HTTP GET or POST request methods which are received by cache node 313.

In this example, cache node 313 has cached network content associated with the requested web page (www.gamma.gov) in a data storage system of cache node 313. This caching can occur responsive to the web page request from end user device 332, a previous request from another end user device for network content associated with www.gamma.gov, or due to a ‘pre-caching’ process which caches predetermined website content prior to end user requests.

As noted above, among the content associated with www.gamma.gov is a tracking element, such as a 1×1 pixel transparent GIF image, noted by tracking GIF ‘C’ in FIGS. 3 and 4. This tracking element can also be cached by cache node 313, and delivered to end user device 332 responsive to a request for the various content associated with www.gamma.gov. However, in this second example, the tracking element is not initially cached by cache node 313, and instead is generated by cache node 313. Cache node 313 can interpret properties of the web page associated with the web page request of end user device 332 to generate any tracking elements included in the web page. This can include a transparent GIF image, such as indicated by URL ‘C’ of www.gamma.gov. The generation process can include creating a new file with properties indicated by the web page HTML or Javascript, among other code or scripts. An existing file can be replicated to create the tracking element for www.gamma.gov, such as copying an image file, renaming, and adjusting associated properties to create the tracking elements indicated by www.gamma.gov.

The HTML markup or other associated data for www.gamma.gov can include embedded pictures, text, and further URLs that reference other content. The tracking element can be referenced among these further URLs included in www.gamma.gov, and thus end user device can request the content for the tracking element referenced by an associated URL. End user device 332 issues a request for the image associated with the tracking element, and the request can include further parameters, such as query string portions, which are included with the request. Cache node 313 then transfers GIF image ‘C’ responsive to the image request by end user device 332. In further examples, the tracking element is not generated or not delivered to end user device 332, such as when cache node 313 responds with an HTTP 204 “no content” message.

Cache node 313 can process the parameters or query string portions included with the request for the tracking element to identify various properties of end user device 332. The properties can include various information about the request, such as a network address of end user device 332 originating the request, an identity or address of the web page associated with the content request (such as www.gamma.gov), a time of the content request, or other properties. Additionally, the properties can include various information about the software environment of end user device 332, such as browser type, application type, or operating system, among other information. These properties can be included in parameters accompanying the request for the tracking element, the request for the associated web page, or derived from the communications between end user device 332 and cache node 313.

The properties associated with end user device 332 and the various content requests for the web page and tracking element can be stored by cache node 313. Furthermore, in this example, properties associated with both web page requests can be correlated. Cache node 313 can use the requests by end user device 332 for the tracking elements associated with each web page requested by end user device 332. Cache node 313 can determine that both web page requests were initiated by the same end user device. Cache node 313 can identify a sequence of web pages for end user device 332, such as which web pages were requested in which order. Further web page requests can be included in these determinations which can accumulate statistics and properties associated with end user device 332 over a period of time.

In some examples, these properties and correlations between web page requests are transferred for delivery to a further system, such as analytics system 380 which can store the properties and correlations to perform various analyses and analytics on the properties from end user device 332 and other end user devices for many web page requests and tracking elements. One or more messages can be transferred to analytics system 380, such as tracking information message 382, which indicates the various properties and correlations determined by cache node 313 for the various end user requests and tracking elements. Analytics system 380 can store this tracking information in database 381 for later processing, such as data analytics, statistical processing, advertisement selection and monitoring, or page hit rate determination, among other web traffic monitoring and analysis processes.

Although FIG. 4 shows web page requests for end user device 332 being received and serviced by cache node 313, other configurations are possible. For example, more than one cache node can service requests from end user device 332 and these more than one cache nodes can communicate the properties determined for end user device 332 from the tracking elements between each other.

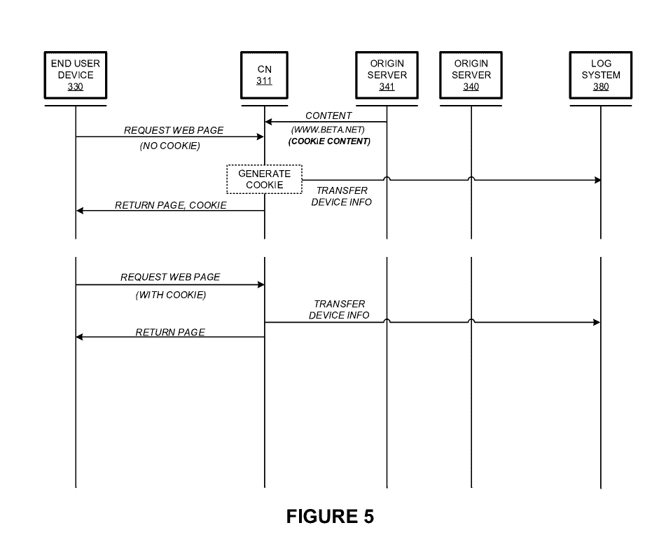

FIG. 5 is a sequence diagram illustrating a method of operating communication system 300. In FIG. 5, end user device 330 requests a web page from cache node 311. The web page can comprise various markup language, text, and scripts which reference other content, such as images, videos, text, and the like. This other content can be referenced in the web page using one or more links or URLs.

End user device 330 can follow a domain name lookup process to receive a network address of a particular cache node responsive to a domain name lookup request with a DNS system. This network address can direct content requests for that associated domain name to a selected cache node, specifically cache node 311 in this example. Once the network address is obtained, then end user device 330 issues a content request for a web resource, such as for a web page associated with example domain name www.beta.net. This content request can comprise one or more HTTP GET or POST request methods which are received by cache node 311.

Among the content associated with the requested web page, one or more embedded tracking elements can be included, such as FIG. 4 discuses. However, in this example, a tracking cookie is associated with the web page or content requested by user device 330.

Tracking cookies are used in network content, such as websites, e-commerce systems, and advertising websites, to follow users during a first associated session on the site and again on any subsequent site visits. User behavior (such as which pages the users hit or request, how long the users stay on a web page, and the like) provides valuable long-term and aggregate information about site flow and usability. Some cookies are referred to as session cookies, and are kept active or stored on the end user device as long as a particular browsing session is active, such as the duration of a visit to a web site or the during execution and use of a web browser application. These session cookies can be removed or deleted from the end user device after the session has ended. Another cookie type is a persistent cookie, which can remain on an end user device across multiple sessions or web browser usages, and can persist when a user enters and quits a browser application.

When a user, such as end user device 330, visits a web site for the first time, the user is transferred a cookie which uniquely identifies the user or user device. In FIG. 5, user device 330 requests a web page which is handled by cache node 311, for example www.beta.net as indicated. If the content associated with www.beta.net is not presently cached by cache node 311, then cache node 311 can request this content from an associated origin server, namely origin server 341 in this example. Additionally, a cookie can be transferred by origin server 341 along with the content that is requested by cache node 311. This cookie can be separated from the content and the content then cached by cache node 311. The content and the cookie can then be transferred for delivery to user device 330. User device 330, such as in a browser application, displays the content and also stores the cookie in a local storage system of the user device.

Alternatively, cache node 311 might not receive a cookie from origin server 341 with the content requested. Cache node 311 can instead generate a cookie for user device 330 in cache node 311, and deliver the generated cookie for delivery to user device 330 along with the content requested. This generated cookie can be cached by cache node 311 for later use, or alternatively generated and cached before a content request by end user device 330 for content of the web site. In some examples, a cookie already exists on user device 330 that is associated with the requested content, and the cookie is transferred by user device 330 along with the request for content of the web page. This example is seen in FIG. 5 after the initial transfer of the cookie. Whenever that same user or user device returns to the web site, the cookie can be received and further analyzed and aggregated to help measure behavior and patterns of the user or user device.

When that same user or user device revisits the web site originally requested, the cache node can receive the cookie from the user device which was stored previously by the user device. This cookie can be processed to identify user information or user device information, such as a unique identifier associated with a user device, generated earlier during the first visit or request above and stored using the cookie in the user device. The cache node then transfers the user device information, such as the unique identifier, to an origin server or tracking system. The tracking system or origin server can use this unique identifier to provide insight into web site browsing behavior or end user behavior. In a further example, a cache node can generate any necessary cookies in the cache node instead of requesting cookies from an origin server. Thus, in the further example, only website content is requested and cached in the cache node, and any user requests for that content can responsively have the cache node generate cookies for the content without involvement of the origin server.

During any cookie process described above, such as after a cookie is received from end user device 330 or after generation of a cookie by cache node 311, information related to the cookie can be transferred for delivery to log system 380 or any other tracking system, as shown in FIG. 5. This information can comprise a unique identifier for user device 330, such as a pseudo-random number which can be generated by cache node 311 and used to represent end user device 330. In other examples, this information indicates an identity of user device 330, such as a network address, user identity, or other information which can uniquely identify user device 330 during return visits to a particular web page or site.

Although FIG. 5 shows web page requests for end user device 330 being received and serviced by cache node 311, other configurations are possible. For example, more than one cache node can service requests from end user device 330 and these more than one cache nodes can communicate the properties determined for end user device 330 from the tracking elements between each other. It should also be noted that any end user device in FIG. 3 can request network content from any cache node of content delivery network 310.

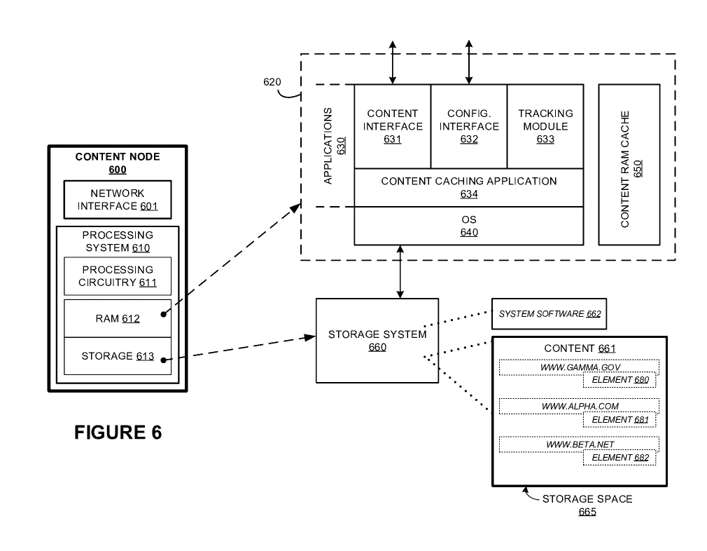

To further describe the equipment and operation of a cache node, FIG. 6 is provided which illustrates cache node 600. Cache node 600 can be an example of cache node 110 of FIG. 1 and cache nodes 311-313 of FIG. 3, although variations are possible. Cache node 600 includes network interface 601 and processing system 610. Processing system 610 includes processing circuitry 611, random access memory (RAM) 612, and storage 613, although further elements can be included, such as discussed in FIGS. 1 and 3. Example contents of RAM 612 are further detailed in RAM space 620, and example contents of storage 613 are further detailed in storage system 660.

Processing circuitry 611 can be implemented within a single processing device but can also be distributed across multiple processing devices or sub-systems that cooperate in executing program instructions. Examples of processing circuitry 611 include general purpose central processing units, microprocessors, application specific processors, and logic devices, as well as any other type of processing device. In some examples, processing circuitry 611 includes physically distributed processing devices, such as cloud computing systems.

Network interface 601 includes one or more network interfaces for communicating over communication networks, such as packet networks, the Internet, and the like. The network interfaces can include one or more local or wide area network communication interfaces which can communicate over Ethernet or Internet protocol (IP) links. Network interface 601 can include network interfaces configured to communicate using one or more network addresses, which can be associated with different network links. Examples of network interface 601 include network interface card equipment, transceivers, modems, and other communication circuitry.

RAM 612 and storage 613 together can comprise a non-transitory data storage system, although variations are possible. RAM 612 and storage 613 can each comprise any storage media readable by processing circuitry 611 and capable of storing software. RAM 612 can include volatile and nonvolatile, removable and non-removable media implemented in any method or technology for storage of information, such as computer readable instructions, data structures, program modules, or other data. Storage 613 can include non-volatile storage media, such as solid state storage media, flash memory, phase change memory, magnetic memory, or as illustrated by storage system 460 in this example. RAM 612 and storage 613 can each be implemented as a single storage device but can also be implemented across multiple storage devices or sub-systems. RAM 612 and storage 613 can each comprise additional elements, such as controllers, capable of communicating with processing circuitry 611.

Software stored on or in RAM 612 or storage 613 can comprise computer program instructions, firmware, or some other form of machine-readable processing instructions having processes that when executed a processing system direct cache node 600 to operate as described herein. For example, software drives cache node 600 to receive requests for content, determine if the content is stored in cache node 600, retrieve content from origin servers, transfer content to end user devices, manage data storage systems for handling and storing the content, among other operations. The software can also include user software applications. The software can be implemented as a single application or as multiple applications. In general, the software can, when loaded into a processing system and executed, transform the processing system from a general-purpose device into a special-purpose device customized as described herein.

RAM space 620 illustrates a detailed view of an example configuration of RAM 612. It should be understood that different configurations are possible. RAM space 620 includes applications 630, operating system (OS) 640, and content RAM cache 650. Content RAM cache 650 includes RAM space for temporary storage of content, such as dynamic random access memory (DRAM).

Applications 630 include content interface 631, configuration interface 632, tracking module 633, and content caching application 634. Content caching application 634 handles caching of content and management of storage spaces, such as content RAM cache 650 and storage space 665, as well as exchanges content, data, and instructions via content interface 631, configuration interface 632, and tracking module 633. Content caching application 634 can comprise a custom application, Varnish caching software, hypertext transfer protocol (HTTP) accelerator software, or other content caching and storage applications, including variation, modifications, and improvements thereof. Applications 630 and OS 640 can reside in RAM space 620 during execution and operation of cache node 600, and can reside in system software storage space 662 on storage system 660 during a powered-off state, among other locations and states. Applications 630 and OS 640 can be loaded into RAM space 620 during a startup or boot procedure as described for computer operating systems and applications.

Content interface 631, configuration interface 632, and tracking module 633 each allow a user to interact with and exchange data with content caching application 634. In some examples, each of content interface 631, configuration interface 632, and tracking module 633 comprise an application programming interface (API). Content interface 631 allows for exchanging content for caching in cache node 600 by content caching application 634, and can also receive instructions to purge or erase data from cache node 600. Content interface 631 can retrieve tracking elements as well as network and web page content from origin servers for delivery to end users. Configuration interface 632 allows for altering the configuration of various operational features of content caching application 634. In some examples, configuration interface 632 comprises a scripting language interface, such as Varnish Configuration Language (VCL), Perl, PHP, Javascript, or other scripting or interpreted language-based interfaces. Tracking module 633 can log and track requests by end user devices for tracking elements found in various web pages cached by content node 600, and deliver log data or tracking information to external systems, among other operations. Content interface 631, configuration interface 632, and tracking module 633 can each communicate with external systems via network interface 601 over any associated network links. In further examples, one or more of elements 631-634 are implemented in VCL or VCL modules.

Storage system 660 illustrates a detailed view of an example configuration of storage 613. Storage system 660 can comprise flash memory such as NAND flash or NOR flash memory, phase change memory, magnetic memory, among other solid state storage technologies. As shown in FIG. 6, storage system 660 includes system software 662, as well as content 661 stored in storage space 665. As described above, system software 662 can be a non-volatile storage space for applications 630 and OS 640 during a powered-down state of cache node 600, among other operating software. Content 661 includes cached content, such as the web content examples in FIG. 1, which can include text, data, pictures, video, audio, web pages, scripting, code, dynamic content, or other network content. Content 661 can also include tracking elements, such as transparent GIFs, web bugs, Javascript tracking elements, among other tracking elements. In this example, content 661 includes network content and web pages associated with one or more websites, as indicated by www.gamma.gov, www.alpha.com, and www.beta.net, along with associated tracking elements 680-682.

Cache node 600 is generally intended to represent a computing system with which at least software 630 and 640 are deployed and executed in order to render or otherwise implement the operations described herein. However, cache node 600 can also represent any computing system on which at least software 630 and 640 can be staged and from where software 630 and 640 can be distributed, transported, downloaded, or otherwise provided to yet another computing system for deployment and execution, or yet additional distribution.

The included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the invention. Those skilled in the art will also appreciate that the features described above can be combined in various ways to form multiple embodiments. As a result, the invention is not limited to the specific embodiments described above, but only by the claims and their equivalents.

What is claimed is:

1. A method of operating a cache node that caches content for delivery to end user devices, the method comprising:
caching web page content and a tracking element, the web page content comprising a portion corresponding to the tracking element;
receiving a content request from an end user device for the tracking element and responsively providing the tracking element to the end user device;
identifying properties of the end user device based at least on the content request; and
transferring the properties of the end user device for delivery to a tracking system.

2. The method of claim 1, wherein the content request comprises a hypertext transfer protocol (HTTP) GET request for the tracking element that is accompanied by a uniform resource locator (URL) for the tracking element and indicating ones of the properties in a query string portion.

3. The method of claim 1, wherein the tracking element comprises a tracking cookie.

4. The method of claim 1, wherein the portion corresponding to the tracking element comprises a link to the tracking element, and wherein the tracking element is hosted by a different content server than the web page content prior to caching in the cache node.

5. The method of claim 1, further comprising:
caching second web page content and a second tracking element, the second web page content comprising a portion corresponding to the second tracking element;
receiving a second content request from the end user device for the second tracking element and responsively providing the second tracking element to the end user device;
identifying second properties of the end user device based at least on the second content request;
correlating the properties to the second properties to determine that the second content request is associated with the end user device; and
transferring for delivery to the tracking system the second properties of the end user device and an indication that the second properties are associated with the first properties.

6. The method of claim 1, further comprising:
prior to receiving the content request, retrieving the web page content and the tracking element from an origin server which hosts the web page content, and caching the web page content and the tracking element in the cache node.

7. The method of claim 1, further comprising:
retrieving the web page content from an origin server which hosts the web page content;
determining that the web page content comprises the portion corresponding to the tracking element, responsively generating the tracking element based at least on properties of the web page content, and caching the tracking element in the cache node.

8. The method of claim 1, further comprising:
retrieving the web page content from an origin server which hosts the web page content;
determining that the web page content comprises the portion corresponding to the tracking element, responsively retrieving the tracking element from a content server which hosts the tracking element, and caching the tracking element in the cache node.

9. A computer apparatus to operate a cache node that caches content for delivery to end user devices, the computer apparatus comprising:
processing instructions that direct the cache node, when executed by the cache node, to:
cache web page content comprising a portion corresponding to a tracking element;
receive a content request from an end user device for the portion of the web page content corresponding to the tracking element;
identify properties of the end user device based at least on the content request;
transfer the properties of the end user device for delivery to a tracking system; and
one or more non-transitory computer readable media that store the processing instructions.

10. The computer apparatus of claim 9, wherein the content request comprises a hypertext transfer protocol (HTTP) GET request for the portion that is accompanied by a uniform resource locator (URL) indicating ones of the properties in a query string portion.

11. The computer apparatus of claim 9, wherein the tracking element comprises a tracking cookie.

12. The computer apparatus of claim 9, wherein the processing instructions further direct the cache node to:
cache second web page content comprising a second portion corresponding to a second tracking element;
receive a second content request from the end user device for the second portion of the second web page content corresponding to the second tracking element;
identify second properties of the end user device based at least on the second content request;
correlate the properties to the second properties to determine that the second content request is associated with the end user device; and
transfer for delivery to the tracking system the second properties of the end user device and an indication that the second properties are associated with the first properties.

13. The computer apparatus of claim 9, wherein the processing instructions further direct the cache node to:
responsive to the content request, provide the tracking element to the end user device, where the tracking element comprises transparent image content.

14. The computer apparatus of claim 9, wherein the processing instructions further direct the cache node to:
responsive to the content request, indicate a hypertext transfer protocol (HTTP) 204 message to the end user device and withhold transfer of the tracking element.

15. The computer apparatus of claim 9, wherein the processing instructions further direct the cache node to:
retrieve the web page content from an origin server which hosts the web page content;
determine that the web page content comprises the portion corresponding to the tracking element, responsively retrieving the tracking element from a content server which hosts the tracking element, and caching the tracking element in the cache node.

16. The computer apparatus of claim 9, wherein the processing instructions further direct the cache node to:
retrieve the web page content from an origin server which hosts the web page content;
determine that the web page content comprises the portion corresponding to the tracking element, and responsively generate the tracking element based at least on properties of the web page content.

17. A cache node that caches content for delivery to end user devices, the cache node comprising:
a storage system configured to cache web page content comprising a portion corresponding to a tracking element;
responsive to a content request from an end user device for the portion of the web page content corresponding to the tracking element, processing circuitry configured to identify properties of the end user device based at least on the content request; and
a network interface configured to transfer the properties of the end user device for delivery to a tracking system.

18. The cache node of claim 17, wherein the content request comprises a hypertext transfer protocol (HTTP) GET request for the portion that is accompanied by a uniform resource locator (URL) indicating ones of the properties in a query string portion.

19. The cache node of claim 17, comprising:
the storage system configured to cache second web page content comprising a second portion corresponding to a second tracking element;
responsive to a second content request from the end user device for the second portion of the second web page content corresponding to the second tracking element, the processing circuitry configured to identify second properties of the end user device based at least on the second content request;
the processing circuitry configured to correlate the properties to the second properties to determine that the second content request is associated with the end user device; and
the network interface configured to transfer for delivery to a tracking system the second properties of the end user device and an indication that the second properties are associated with the first properties.

20. The cache node of claim 17, comprising:
responsive to the content request, the network interface configured to provide the tracking element to the end user device, where the tracking element is cached by the cache node and comprises transparent image content.
